(19) United States
(12) Patent Application Publication
(10) Pub. No.: US 2019/0238349 A1
(43) Pub. Date: Aug. 1, 2019

(54) MIXED FOUR PAIR AND SINGLE PAIR CABLING ARCHITECTURE

(71) Applicant: COMMSCOPE, INC. OF NORTH CAROLINA, Hickory, NC (US)

(72) Inventors: Bryan Scott MOFFITT, Richardson, TX (US); Benji BOBAN, Wylie, TX (US)

(21) Appl. No.: 16/332,293

(22) PCT Filed: Sep. 11, 2017
(86) PCT No.: PCT/US2017/050928

§ 371 Date: Mar. 11, 2019

Related U.S. Application Data
(60) Provisional application No. 62/393,346, filed on Sep. 12, 2016.

(51) Int. Cl. H04L 12/10; H04L 12/46

(52) U.S. Cl. CPC H04L 12/10; H04L 12/4625

(57) ABSTRACT

A network consolidation point has a passive coupler and an active converter. The passive coupler is configured to couple a first backbone-coupled, four pair Ethernet cable to a communications outlet-coupled four pair Ethernet cable. The active converter is configured to couple a second backbone-coupled, four pair Ethernet cable to a first communications outlet-coupled, single pair Ethernet cable. The active converter converts data transmitted over the backbone-coupled, four pair Ethernet cable to data transmittable over the communications outlet-coupled, single pair Ethernet cable.

### CROSS-REFERENCE TO RELATED APPLICATION

This application is being filed on Sep. 11, 2017 as a PCT International Patent Application and claims the benefit of U.S. Patent Application Ser. No. 62/393,346, filed on Sep. 12, 2016, the disclosure of which is incorporated herein by reference in its entirety.

### TECHNICAL FIELD

The present disclosure is directed to communications network cabling architecture and, more particularly, to communications network cabling architecture that includes mixed four pair and single pair horizontal communications cabling.

### BACKGROUND

Over the past 10 years, many new applications have come to utilize information technology (IT) infrastructure, specifically, Ethernet cabling, as the physical layer medium for information transport. Ethernet systems have become commonplace in office buildings, manufacturing facilities and even homes. However, cabling architectures for Ethernet networks and Ethernet hardware, e.g., cables, connectors, etc., continue to evolve. This evolution can require cost and time prohibitive Ethernet re-cabling to stay on the cutting edge of Ethernet communication.

### SUMMARY

The present disclosure addresses the ability to maintain cutting edge Ethernet communication without the significant time and monetary costs of re-cabling. Rather, existing zoned Ethernet cabling architecture can be used in conjunction with drop cables and network consolidation points equipped with active converters to accommodate evolving changes in the physical and data link layers of Ethernet communication.

One aspect of the present disclosure is direct to a network consolidation point having a passive coupler and an active converter. The passive coupler is configured to couple a first backbone-coupled, four pair Ethernet cable to a communications outlet-coupled four pair Ethernet cable. The active converter is configured to couple a second backbone-coupled, four pair Ethernet cable to a first communications outlet-coupled, single pair Ethernet cable. The active converter converts data transmitted over the backbone-coupled, four pair Ethernet cable to data transmittable over the communications outlet-coupled, single pair Ethernet cable.

Another aspect of the present disclosure is directed to a system comprising an Ethernet network consolidation point, first and second four pair Ethernet cables, a four pair Ethernet drop cable, and a single pair Ethernet drop cable. The Ethernet network consolidation point includes a passive coupling device and an active coupling device. The first and second four pair Ethernet cables are coupled intermediate the Ethernet network consolidation point and an Ethernet backbone. The first four pair Ethernet cable is coupled to the passive coupling device and the second four pair Ethernet cable is coupled to the active coupling device. The four pair Ethernet drop cable is also coupled to the passive coupling device where the passive coupling device enables data transmitted over the first four pair Ethernet cable to be transmitted over the four pair Ethernet drop cable without purposeful modification of the data. The single pair Ethernet drop cable is also coupled to the active coupling device where the active coupling device converts data transmitted over the second four pair Ethernet cable to data transmittable over the first single pair Ethernet drop cable by purposeful modification of the data. The purposeful modification of the data comprises converting between first and second IEEE Ethernet standards. The active coupling device can additionally be configured to convert power transmitted over the second four pair Ethernet cable to power transmittable over the single pair Ethernet drop cable.

Still another aspect of the present disclosure is directed to a method including: (a) receiving, at a network consolidation point, first data transmitted in accordance with a first Ethernet standard from an Ethernet backbone; (b) converting, at the network consolidation point, the received first data to converted first data, the converted first data consistent with a second Ethernet standard; and (c) transmitting, from the network consolidation point, the converted first data.

The above summary is not intended to describe each embodiment or every implementation. A more complete understanding will become apparent and appreciated by referring to the following detailed description and claims in conjunction with the accompanying drawings.

### BRIEF DESCRIPTION OF THE DRAWINGS

FIG. 1A is a schematic of an exemplary traditional Ethernet communications network cabling architecture.

FIG. 1B illustrates an exemplary connector used with the cabling architecture of FIG. 1A.

FIG. 2A is a schematic of an exemplary zone-based Ethernet communications network cabling architecture including a passive consolidation point.

FIG. 2B provides a grid representation of the zone-based Ethernet communications network cabling architecture of FIG. 2A.

FIG. 3 is a schematic illustrating various office-based utilities that can take advantage of a passive consolidation point.

FIG. 4 is a schematic of an exemplary zone-based Ethernet communications network cabling architecture including an active consolidation point according to the present disclosure.

FIG. 5 is a simplified block diagram of the active consolidation point according to the present disclosure.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Reference will now be made in detail to exemplary implementations of the present invention, examples of which are illustrated in the accompanying drawings. While exemplary implementations are provided, other implementations are possible in light of the specification. As such, changes may be made to the exemplary implementations described herein without departing from the spirit and scope of the invention. The following detailed description does not limit the invention; but instead, the scope of the invention is defined by the appended claims and their equivalents. Wherever possible, the same reference numbers may be used throughout the drawings to refer to the same or like parts.

The present disclosure is directed to communications network cabling architecture and, more particularly, to communications network cabling architecture that includes mixed four pair and single pair horizontal communications cabling.

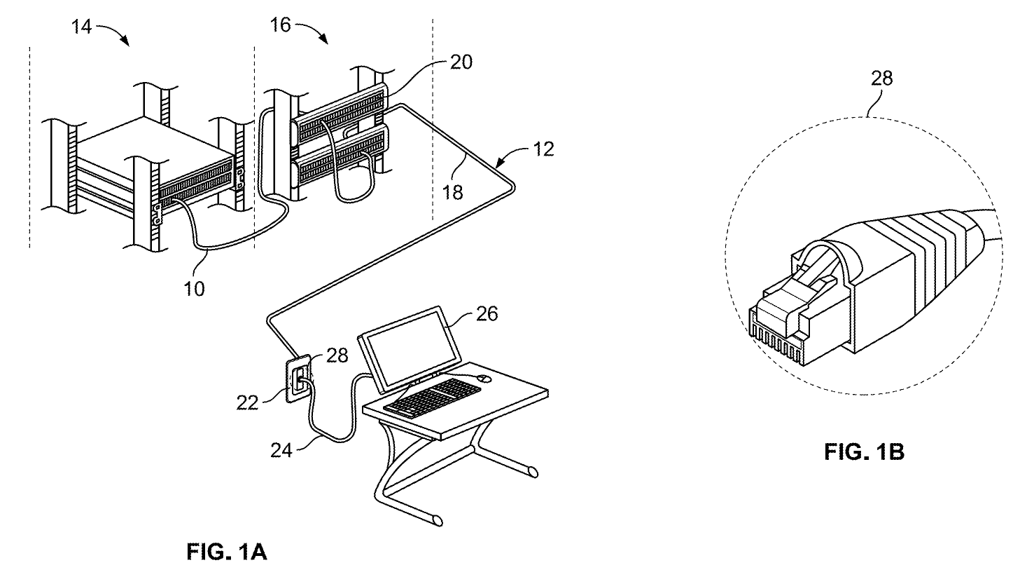

Within a commercial building, see FIG. 1A, the infrastructure for communications networks includes two basic segments: the backbone 10 (or riser) and the horizontal 12. The backbone 10 (e.g., the line or set of lines that local area networks (LANs) connect to for wide area network (WAN) connection, or within a LAN to span distances efficiently) connects communication rooms 14 to centrally located equipment rooms 16 with backbone media, e.g., OM3 or OM4 multimode fiber to support high-bandwidth applications or copper cabling for lower bandwidth applications. The horizontal section 12 of the network includes the connection, e.g., the horizontal cable 18, between a patch panel 20 in the equipment room 16 (or communications room 14) and a communications outlet 22 in a work area, as well as the connection, e.g., work area cable 24, between the communications outlet 22 and an end device 26. The horizontal cabling, e.g., horizontal cable 18 and work area cable 24, typically comprises four pair copper cabling (four twisted or untwisted pairs/shielded or unshielded) connected via a communications connector, such as the RJ-45 connector 28 illustrated in FIG. 1B.

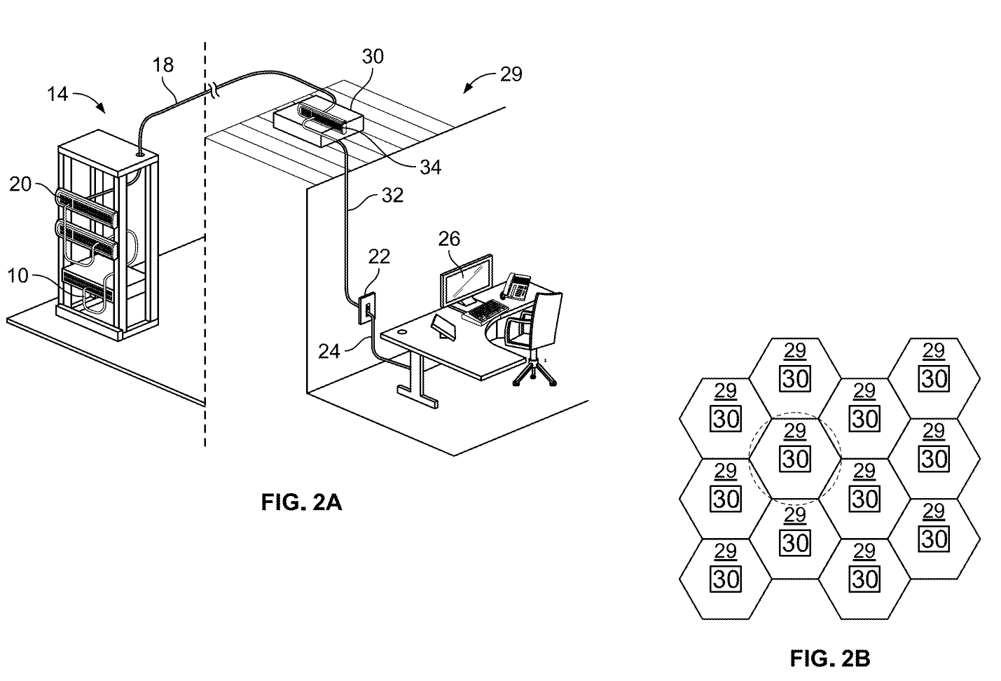

Referring to FIG. 2A, an alternative horizontal distribution strategy known as zone cabling utilizes cable runs from a floor's communications room 14 to specific building service areas or zones 29. A consolidation point 30 within each zone 29 provides a permanent intermediate connection with fixed horizontal cabling, e.g., horizontal cable 18, between the communications room 14 and the consolidation point 30. Extension or “drop cables” 32 are then patched from the patch panel 34 at the consolidation point 30 to the one or more communications outlets 22 within the zone 29 and/or directly to the one or more end devices 26 within the zone 29. By using a permanent horizontal link, e.g., cable 18, between the communications room 14 and the consolidation point 30, a zone distribution system provides greater flexibility with reconfiguring open office spaces, placing distributed endpoint devices, staging installations, or locating connectivity in easily accessible locations through use of multiple drop cables 32. In some communications cabling installations, zone cabling is implemented by defining a grid of evenly sized zones 29, see FIG. 2B, with a consolidation point 30 located within each zone 29 for maximum flexibility in connecting, adding, and moving end devices.

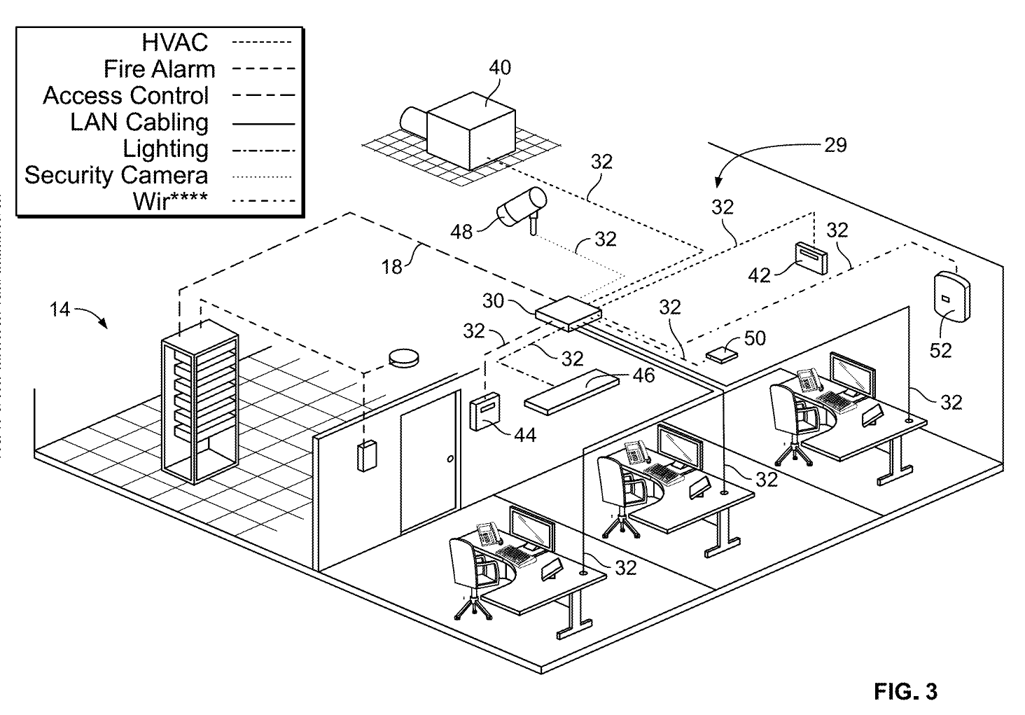

Referring to FIG. 3, zone cabling becomes even more effective with the introduction of other utilities into the zone 29. The different utilities, while having varied equipment and end points, can make use of the permanent horizontal cabling 18 and various drop cables 32 in combination with adapters or converters at the utility endpoints to convert data transmitted on four pair cabling to a format usable by the utility. FIG. 3 provides examples of various utilities and their end points that can benefit from zone cabling and central consolidation point 30. The exemplary utilities include: (a) heating ventilation and air conditioning (HVAC) with endpoints comprising HVAC unit 40 and controller 42 connected through consolidation point 30; (b) access control with and endpoint comprising access control panel 44 connected at consolidation point 30; (c) lighting with an endpoint comprising light 46 connected at consolidation point 30; (d) security with an endpoint comprising security camera 48 connected at consolidation point 30; and (e) wireless with endpoints comprising access points 50 and 52 connected at consolidation point 30.

The network communications cabling architecture described above utilizes a consolidation point 30 whose function is to act as a passive intermediary in the transmission of data, e.g., no operations are performed at the consolidation point 30 to purposefully alter the transmission of data as it transfers from cable to cable. In contrast, the present disclosure is directed to a consolidation point that can operate either as a passive element within the cabling infrastructure or as an active element within the cabling infrastructure.

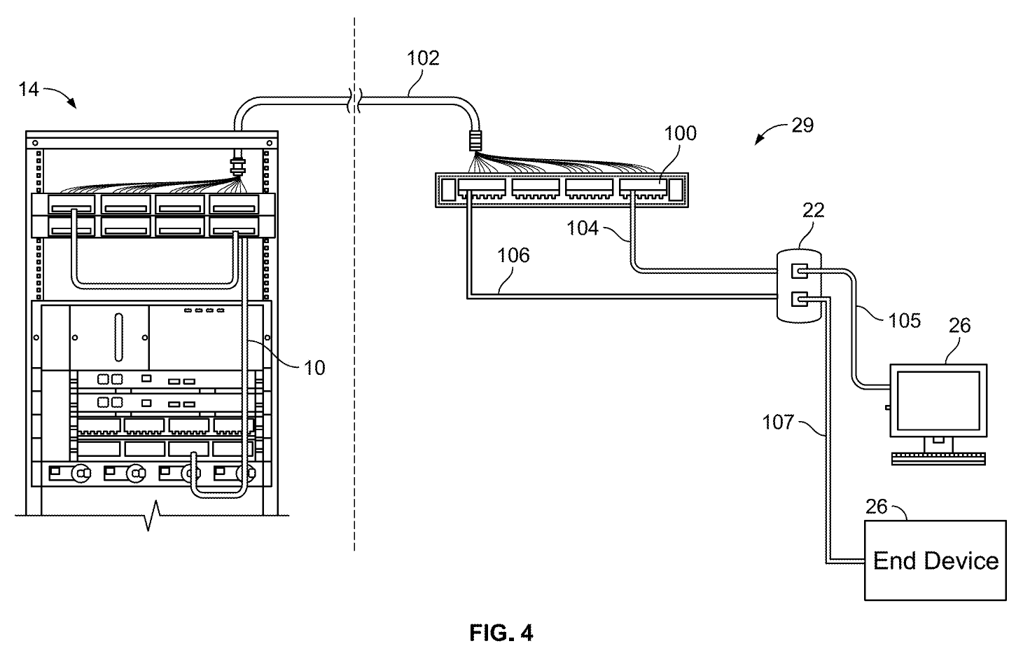

Referring to FIG. 4, a mixed four pair and single pair consolidation point 100 within a zone 29 is illustrated. As shown, the consolidation point 100 is coupled intermediate a communications room 14 and communications outlet 22. A cable 102, utilized as fixed horizontal cabling, connects the consolidation point 100 and the communications room 14 (or equipment room 16). Cable 102 is configured as a four pair copper Ethernet cable for transmission of data alone, or for transmission of both data and DC power (e.g., power over Ethernet, PoE, PoE+). The transmission of data over cable 102 occurs in accordance with the Institute of Electrical and Electronics Engineers (IEEE) one Gigabit Ethernet standards, e.g., 1000Base-T. Note that IEEE standard 802.3ab provides the physical layer specifications and the data link layer's media access control (MAC) specifications for 1000Base-T. Further, IEEE standards 802.3af and IEEE 802.3at provide the physical layer specifications for PoE and PoE+, respectively. Cabling suitable for four-pair Ethernet data and DC power transmission include, but are not limited to, CAT5e, CAT6, or CAT7 cabling. Suitable connectors, e.g., RJ-45 connectors, are provided at each end of the cable 102.

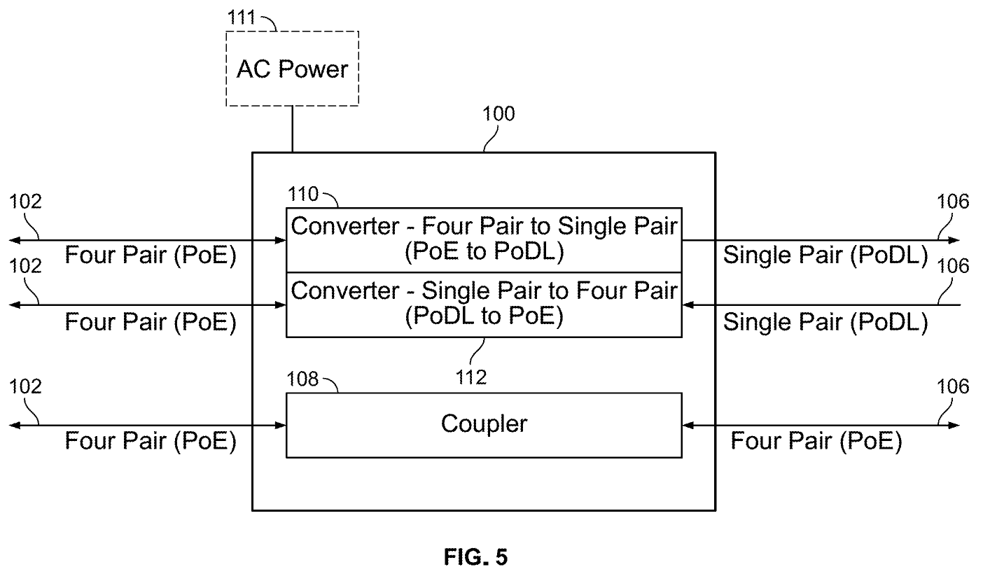

Cables 104 and 106 serve as drop cables connecting the consolidation point 100 and the communications outlet 22 (or end device 26). Cable 104 is representative of a four pair Ethernet cable that is the same or similar to cable 102; cable 104 operates in accordance with the same or similar IEEE standards as cable 102. Suitable connectors, e.g., RJ-45 connectors, are provided at each end of the cable 104. Consolidation point 100 provides a coupler 108 (see FIG. 5) as a passive coupling device between cables 102 and 104 enabling transmission of data, or transmission of data and power. A compatible work cable 105 couples the communications outlet 22 to the end device 26, if necessary.

Cable 106 is representative of a single pair Ethernet cable configured for one Gigabit Ethernet data, or data and power (e.g., power over data line (PoDL)), transmission. The IEEE has recently released an Ethernet standard, e.g., 1000Base-T1 for just such a cable and while 1000Base-T1 is generally directed to automotive and industrial environments, the standard or a variation thereof can be adapted to non-automotive/non-industrial environments such as an office environment as illustrated herein. Note that IEEE standard 802.3 bp provides the physical layer specifications and the data link layer's media access control (MAC) specifications for 1000Base-T1. Further, IEEE draft standard 802.3bu provides the physical layer specifications for PoDL. Suitable single pair connectors, e.g., MATEnet™ connectors (available from TE Connectivity), or variations thereof, are provided at each end of cable 106. A compatible work cable 107 couples the communications outlet 22 to the end device 26, if necessary.

Referring to FIG. 5, a simplified schematic of the consolidation point 100 is illustrated. Within the consolidation point 100, and intermediate the coupling of the four pair cable 102 and the single pair cable 106, an active converter 110 is provided. The active converter 110 can be powered by DC power transmitted through cable 102 and/or by an external AC power supply 111. The active converter 108 operates to convert data and/or power received over four pair cable 102 to data and/or power that is transmittable over single pair cable 106, e.g., changing from a first IEEE Ethernet standard to a second different IEEE Ethernet standard. As such, cable 106 can be deemed an active, single pair drop cable. Similarly a reverse, or backward, active converter 112 can be combined with or exist independently of active converter 110, to convert data and/or power received over single pair cable 106 to data and/or power that is transmittable over four pair cable 102, e.g., converting from the second IEEE Ethernet standard to the first IEEE Ethernet standard. In certain examples, a four pair cable 102 is used to transmit to a plurality of single pair cables 106, e.g., a four pair data connection that is adapted to transmit to eight separate one pair drop cables with data converted in the converter.

The above-described cabling architecture for combined mixed four pair and single pair horizontal cabling enables newly developed single pair applications to be supported in a way that is integrated into existing four pair cabling infrastructure without requiring users to completely dismiss or replace their current network cabling infrastructure.

Systems, devices or methods disclosed herein may include one or more of the features structures, methods, or combination thereof described herein. For example, a device or method may be implemented to include one or more of the features and/or processes above. It is intended that such device or method need not include all of the features and/or processes described herein, but may be implemented to include selected features and/or processes that provide useful structures and/or functionality.

Various modifications and additions can be made to the disclosed embodiments discussed above. Accordingly, the scope of the present disclosure should not be limited by the particular embodiments described above, but should be defined only by the claims set forth below and equivalents thereof.

What is claimed:

1. A network consolidation point comprising:
a passive coupler configured to couple a first backbone-coupled, four pair Ethernet cable to a communications outlet-coupled, four pair Ethernet cable; and
an active converter configured to couple a second backbone-coupled, four pair Ethernet cable to a first communications outlet-coupled, single pair Ethernet cable, wherein the active converter converts data transmitted over the backbone-coupled, four pair Ethernet cable to data transmittable over the communications outlet-coupled, single pair Ethernet cable.

2. The network consolidation point of claim 1, wherein the active converter additionally converts power transmitted over the second backbone-coupled, four pair Ethernet cable to power transmittable over the first communications outlet-coupled, single pair Ethernet cable.

3. The network consolidation point of claim 1, further comprising a reverse active converter configured to couple a second communications outlet-coupled, single pair Ethernet cable to a third backbone-coupled, four pair Ethernet cable, wherein the reverse active converter converts data transmitted over the second communications outlet-coupled, single pair Ethernet cable to data transmittable over third backbone-coupled, four pair Ethernet cable.

4. The network consolidation point of claim 3, wherein the reverse active converter additionally converts power transmitted over the second communications outlet-coupled, single pair Ethernet cable to power transmittable over third backbone-coupled, four pair Ethernet cable.

5. A system comprising:
an Ethernet network consolidation point including a passive coupling device and an active coupling device;
first and second four pair Ethernet cables coupling the Ethernet network consolidation point to an Ethernet backbone, wherein the first four pair Ethernet cable is coupled to the passive coupling device and the second four pair Ethernet cable is coupled to the active coupling device;
a four pair Ethernet drop cable coupled to the passive coupling device, wherein the passive coupling device enables data transmitted over the first four pair Ethernet cable to be transmitted over the four pair Ethernet drop cable without purposeful modification of the data; and
a first single pair Ethernet drop cable coupled to the active coupling device, wherein the active coupling device converts data transmitted over the second four pair Ethernet cable to data transmittable over the first single pair Ethernet drop cable by purposeful modification of the data.

6. The system of claim 5, wherein the purposeful modification of the data comprise converting between first and second IEEE Ethernet standards.

7. The system of claim 5, wherein the active coupling device converts power transmitted over the second four pair Ethernet cable to power transmittable over the first single pair Ethernet drop cable.

8. The system of claim 5, wherein the Ethernet network consolidation point further includes a reverse converter.

9. The system of claim 8, wherein the purposeful modification of the data comprises converting the data transmitted over the over the second four pair Ethernet cable from a first IEEE Ethernet standard to a second IEEE standard that is transmittable over the first single pair Ethernet drop cable, and wherein the system further comprises:
a third four pair Ethernet cable coupling the Ethernet network consolidation point to the Ethernet backbone, wherein the third four pair Ethernet cable is coupled to the reverse converter; and
a second single pair Ethernet drop cable coupled to the reverse active coupling device, wherein the reverse active coupling device converts data transmitted over the second single pair Ethernet drop cable from the second IEEE Ethernet standard to the first IEEE Ethernet standard that is transmittable over the third four pair Ethernet cable.

10. The system of claim 9, wherein the reverse active coupling device converts power transmitted over the second single pair Ethernet drop cable to power that is transmittable over the third four pair Ethernet cable

11. A method comprising:
receiving, at a network consolidation point, first data transmitted in accordance with a first Ethernet standard from an Ethernet backbone;
converting, at the network consolidation point, the received first data to converted first data, the converted first data consistent with a second Ethernet standard; and
transmitting, from the network consolidation point, the converted first data.

12. The method of claim 11, further comprising:
receiving, at the network consolidation point, first power transmitted in accordance with a third Ethernet standard from an Ethernet backbone;
converting, at the network consolidation point, the received first power to converted first power, the converted first power consistent with a fourth Ethernet standard; and
transmitting, from the network consolidation point, the converted first power.

13. The method of claim 11, further comprising:
receiving, at the network consolidation point, second data transmitted in accordance with the second Ethernet standard;
converting, at the network consolidation point, the received second data to converted second data, the converted second data consistent with the first Ethernet standard; and
transmitting, from the network consolidation point, the converted second data.

14. The method of claim 13, further comprising:
receiving, at the network consolidation point, first power transmitted in accordance with a third Ethernet standard from an Ethernet backbone;
converting, at the network consolidation point, the received first power to converted first power, the converted first power consistent with a fourth Ethernet standard;
transmitting, from the network consolidation point, the converted first power;
receiving, at the network consolidation point, second power transmitted in accordance with the fourth Ethernet standard;
converting, at the network consolidation point, the received second power to converted second power, the converted second power consistent with the third Ethernet standard; and
transmitting, from the network consolidation point, the converted second power.
